(19) United States
(12) Patent Application Publication
(10) Pub. No.: US 2010/0103187 A1
(43) Pub. Date: Apr. 29, 2010

(54) METHOD OF COLOR GAMUT MAPPING OF COLOR INPUT VALUES OF INPUT IMAGE PIXELS OF AN INPUT IMAGE TO RGBW OUTPUT VALUES FOR AN RGBW DISPLAY, DISPLAY MODULE, AND APPARATUS USING SUCH METHOD

(75) Inventor: Ron LINSSEN, Heerlen (NL)

Correspondence Address: LOWE HAUPTMAN HAM & BERNER, LLP, 1700 DIAGONAL ROAD, SUITE 300, ALEXANDRIA, VA, 22314, US

(73) Assignee: TPO DISPLAYS CORP., Chu-Nan (TW)

(21) Appl. No.: 12/575,649

(22) Filed: Oct. 8, 2009

(30) Foreign Application Priority Data
Oct. 23, 2008 (EP) 08167399.8

(51) Int. Cl. G09G 5/10; G09G 5/02; G09G 3/36

(52) U.S. Cl. 345/590; 345/690; 345/88

(57) ABSTRACT

Method, display module and apparatus arranged for color gamut mapping of color input values of input image pixels of an input image to RGBW output values for an RGBW display, the RGBW display comprising red pixels (R), green pixels (G), blue pixels (B) and brightness enhancing pixels (W). The method includes a) analyzing the color input values of the input image pixels of the input image for determining a degree of saturation (S) of the input image; b) determining a brightness-enhancing-pixel utilization factor (WPUR) for the input image in dependence on at least the degree of saturation (S); and c) color mapping of the color input values to the RGBW output values using at least the brightness-enhancing-pixel utilization factor (WPUR).

### CROSS-REFERENCE TO RELATED APPLICATIONS

This application claims the right of priority based on European Patent Application No. 08167399.8 entitled “METHOD OF COLOR GAMUT MAPPING OF COLOR INPUT VALUES OF INPUT IMAGE PIXELS OF AN INPUT IMAGE TO RGBW OUTPUT VALUES FOR AN RGBW DISPLAY, DISPLAY MODULE, DISPLAY CONTROLLER AND APPARATUS USING SUCH METHOD,” filed on Oct. 23, 2008, which is incorporated herein by reference and assigned to the assignee herein.

### FIELD OF INVENTION

The invention relates to a method arranged for color gamut mapping of color input values of input image pixels of an input image to RGBW output values for an RGBW display. Another aspect of the invention relates to a display module comprising an RGBW display. Another aspect of the invention relates to a display controller arranged for controlling an RGBW display. Another aspect of the invention relates to an apparatus comprising such display module.

### BACKGROUND OF THE INVENTION

Matrix displays are nowadays in widespread used in a large variety of applications, ranging from small-sized displays in mobile and handheld apparatuses such as a mobile phone or a digital still-picture camera to large-sized displays for television and computer monitors. Typically, such matrix displays comprise a multitude of red, green and blue pixels in a matrix arrangement. Such matrix display may be referred to as an RGB display. By driving each of the red, green and blue pixels with suitable drive signals, a complete full-color image is composed using the red, green and blue pixels.

When the color input values are RGB input values, the drive signals may be directly determined from the RGB input values. When the color input values are in another color format, e.g. YUV input values, determining the drive signal may include a color conversion of the YUV input values to RGB values, and the drive signals may be directly determined from the determined RGB values. A white image with maximum brightness is then typically shown by the display by driving the red, green and blue pixels with maximum drive levels.

Currently, the most popular type of matrix display is a liquid crystal display (LCD), but alternative types, e.g. organic light emitting diodes (OLED) displays, have also been introduced in the market. A matrix display may be a passive matrix display, or an active matrix display. A LCD display may be a reflective, transmissive or transflective display. A LCD display typically uses a backlight or frontlight for light generation, with the red, green and blue pixels being formed using corresponding color filters.

Recently, displays using brightness enhancing pixels, additional to red, green and blue pixels, have been introduced. The brightness enhancing pixels are typically white pixels, but can alternatively be e.g. yellow pixels. Such matrix display may be referred to as an RGBW display. The brightness of one white pixel, when driven with maximum drive signal, may be typically substantially equal to the brightness of a combination of one red, one green and one blue pixel, when all driven with maximum drive signal, but may also be different. In the following, brightness enhancing pixels may be referred to as white pixels and vice-versa, without an intention to restrict the brightness enhancing pixels to white pixels only.

By using the brightness enhancing pixels, the maximum brightness of the display of an RGBW display may be increased compared to an RGB display. When the display is illuminated with a backlight (or, for a reflective display, with a frontlight), the brightness of the backlight may additionally or alternatively be reduced to reduce power dissipation by the backlight, while having a same maximum brightness. The same maximum brightness may be the same brightness in absolute terms, or may be the same maximum brightness as perceived by a viewer for the RGBW display with the backlight with reduced backlight brightness as the maximum brightness for the RGB display with the backlight at non-reduced backlight brightness. The RGBW display may thus be referred to as being more efficient than a corresponding RGB display.

The increase of efficiency of an RGBW display may be a reason to favour an RGBW display over an RGB display, e.g. when using the display in an apparatus where display brightness may be important, e.g. a display in a mobile phone used outdoors in bright sunlight. However, the RGBW display may also have a disadvantage: it may show an effect known as a simultaneous contrast artifact. Simultaneous contrast may be defined as the relative brightness of a fully saturated image part to a fully white image part. The simultaneous contrast for the RGBW display may be a considerably, e.g. a factor 2, smaller than the simultaneous contrast for the RGB display. As a result, image parts with saturated colors may appear darker on the RGBW display compared to image parts with saturated colors on the RGB display, assumed that white parts on the RGBW display and the RGB display have equal brightness. This effect is usually referred to as the simultaneous contrast artifact. The simultaneous contrast artifact may be annoying as it may be experienced by a viewer as somewhat unnatural or unrealistic.

Prior art methods have aimed to reduce this effect on simultaneous contrast by using a smaller contribution of the white pixel in the complete image. The contribution of the white pixel in the complete image may be referred to as a brightness-enhancing-pixel utilization factor, and may also be referred to as a white pixel utilization ratio (WPUR). The white pixel utilization ratio may be a factor used in converting input RGB data to RGBW driving levels for limiting the contribution of the white pixel. A low white pixel utilization ratio may have a good simultaneous contrast, but may also result in only a small brightness improvement. On the other hand, a large white pixel utilization ratio may result in a large brightness improvement, but may have a poor simultaneous contrast. Prior art methods have used a value of e.g. 70% for the white pixel utilization ratio for obtaining a compromise between brightness improvement and simultaneous contrast deterioration. The white pixel utilization ratio may be implemented as a factor in the color mapping of color input values to RGBW output values and/or a relative area of the white pixel.

However, when using a value of e.g. 70% for the white pixel utilization ratio, an image with only non-saturated colors may be compromised in brightness improvement much more than would be needed to keep the simultaneous contrast at an acceptable level. Also, when using a value of e.g. 70% for the white pixel utilization ratio, an image with a lot of highly saturated colors may still be significantly and notably compromised in simultaneous contrast.

### SUMMARY OF THE INVENTION

It is an aim of the invention to reduce the simultaneous contrast artifact. It is a further aim of further embodiments of the invention to control the level of simultaneous contrast.

Hereto a first aspect of the invention provides a method arranged for color gamut mapping of color input values of input image pixels of an input image to RGBW output values for an RGBW display, the RGBW display comprising red pixels, green pixels, blue pixels and brightness enhancing pixels, the method comprising:
a) analyzing the color input values of the input image pixels of the input image for determining a degree of saturation of the input image;
b) determining a brightness-enhancing-pixel utilization factor for the input image in dependence on at least the degree of saturation;
c) color mapping of the color input values to the RGBW output values using at least the brightness-enhancing-pixel utilization factor.

In a further embodiment, the method further comprises: a2) analyzing the color input values of the input image pixels of the input image for determining a degree of luminance of the input image; and b2) determining the brightness-enhancing-pixel utilization factor is performed in further dependence on the degree of luminance.

Another aspect of the invention provides a display module comprising:
a display comprising red pixels, green pixels, blue pixels and brightness enhancing pixels arranged to be driven with pixel drive values; and
a display controller arranged to:
i) receive color input values of input image pixels of an input image;
a) analyze the color input values of the input image pixels of the input image for determining a degree of saturation of the input image;
b) determine a brightness-enhancing-pixel utilization factor in dependence on at least the degree of saturation;
c) color map the color input values to RGBW output values using at least the brightness-enhancing-pixel utilization factor, and
ii) drive the display with pixel drive values corresponding to the RGBW output values.

In a further embodiment, the display module further comprises:
a light source, the light source being arranged to illuminate an LCD display with a light source brightness, and
a light source controller, the light source controller being arranged to determine the light source brightness in dependence on at least one of:
   the color input values of the input image pixels of the input image,
   the RGBW output values,
   the degree of saturation,
   the degree of luminance, and
   the brightness-enhancing-pixel utilization factor,
and to control the light source.

Another aspect of the invention provides a display controller for driving a display, the display comprising red pixels, green pixels, blue pixels and brightness enhancing pixels arranged to be driven with pixel drive values, the display controller arranged to:
i) receive color input values of input image pixels of an input image;
a) analyze the color input values of the input image pixels of the input image for determining a degree of saturation of the input image;
b) determine a brightness-enhancing-pixel utilization factor in dependence on at least the degree of saturation;
c) color map the color input values to RGBW output values using at least the brightness-enhancing-pixel utilization factor, and
ii) drive the display with pixel drive values corresponding to the RGBW output values.

Another aspect of the invention provides an apparatus comprising:
a display module according to the invention, and
an apparatus controller arranged to provide the input image to the display module.

The foregoing and other features of the invention will be apparent from the following more particular description of embodiment of the invention.

### BRIEF DESCRIPTION OF THE DRAWINGS

The invention will now be further described by way of example only with reference to the accompany drawings in which:

FIG. 1a and FIG. 1b schematically show an apparatus according to the invention;

FIG. 2 schematically shows a pixel arrangement for an RGB display;

FIG. 3a, FIG. 3b and FIG. 3c show pixel arrangements for an RGBW display;

FIG. 4 schematically shows an aspect of a color space for an RGB display;

FIG. 5 schematically shows an aspect of a color space for an RGBW display;

FIG. 6 schematically shows an aspect of a color space for an RGBW display;

FIG. 7 schematically shows a prior art method arranged for color gamut mapping of color input values to RGBW output values for an RGBW display;

FIG. 8 schematically shows an embodiment of a method according to the invention;

FIG. 9 schematically shows an aspect of an embodiment of a method according to the invention;

FIG. 10a, FIG. 10b and FIG. 10c illustrate aspects of embodiments of methods according to the invention; and

FIG. 11 illustrates aspects of further embodiments of methods according to the invention.

### DETAILED DESCRIPTION OF THE PREFERRED EMBODIMENTS

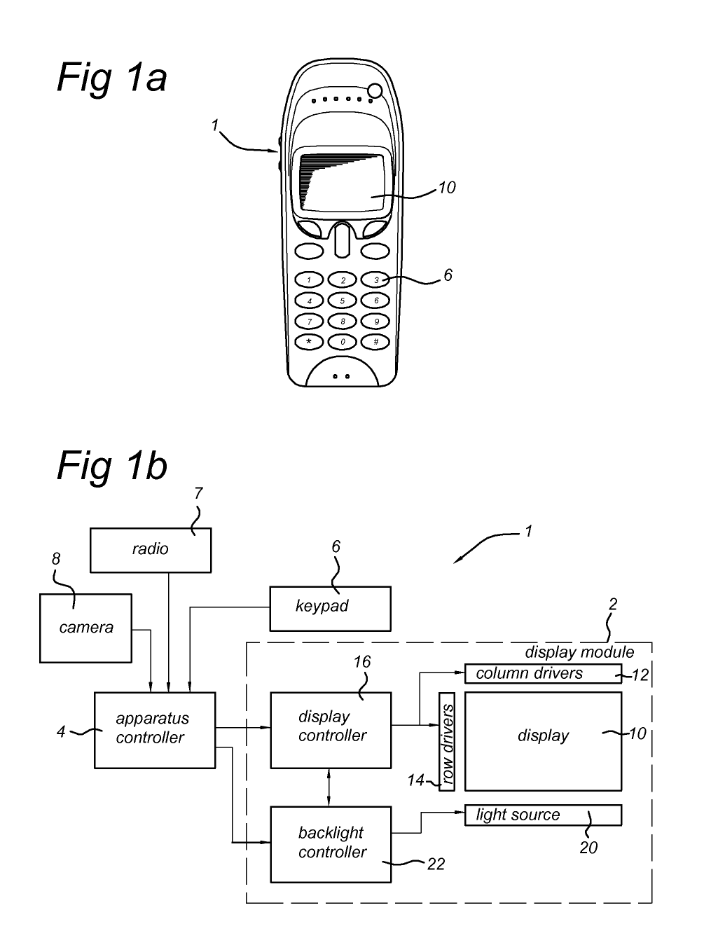

FIG. 1a schematically shows an apparatus 1 according to the invention. The apparatus 1 comprises: a display module 2, and an apparatus controller 4 arranged to provide an input image to the display module 2.

The apparatus 1 may further comprise e.g. a keypad 6 arranged for accepting user input for controlling the apparatus 1, a radio 7 arranged for sending and receiving messages such as voice messages, text messages and/or images, and a camera 8 arranged for taking images. The apparatus 1 may e.g. be a mobile phone, as shown in FIG. 1b, a digital still-picture camera, a car navigation system, a mobile DVD-player or another hand-held consumer appliance, a television, a computer monitor, another large-screen consumer electronics device, or a professional appliance.

The display module 2 comprises a display 10 comprising red pixels R, green pixels G, blue pixels B and brightness enhancing pixels W arranged to be driven with pixel drive values; and a display controller 16 arranged to:
i) receive color input values of input image pixels of an input image;
a) analyze the color input values of the input image pixels of the input image for determining a degree of saturation of the input image;
b) determine a brightness-enhancing-pixel utilization factor WPUR in dependence on at least the degree of saturation;
c) color map the color input values to RGBW output values using at least the brightness-enhancing-pixel utilization factor WPUR, and
ii) drive the display 10 with pixel drive values corresponding to the RGBW output values.

The display controller 16 is in electrical communication with column drivers 12 and row drivers 14, for driving the display 10 with the pixel drive values according to known methods. The display controller 16 may be arranged to receive an input image from the apparatus controller 4 and use the input image to drive the display 10. The input image may alternatively be generated, as a whole or part of it, by the display controller 16, e.g. for providing test images.

In an embodiment, the brightness enhancing pixels are selected from a group comprising white pixels and yellow pixels. The brightness enhancing pixels may thus be formed by either white pixels, or yellow pixels, or a combination of white pixels and yellow pixels.

In an embodiment, the red pixels R, the green pixels G, the blue pixels B and the brightness enhancing pixels W have substantially equal sizes.

Equally sized pixels may be advantageous in manufacturing the display. Equally sized pixels may also be advantageous in terms of perceived display resolution, as a corresponding balance in brightness between a triplet of red, green and blue pixels and the brightness enhancing white pixel may be used to advantage during spatial mapping of color input values to RGBW output values (e.g. using techniques known in the art such as scaling or sub-pixel rendering).

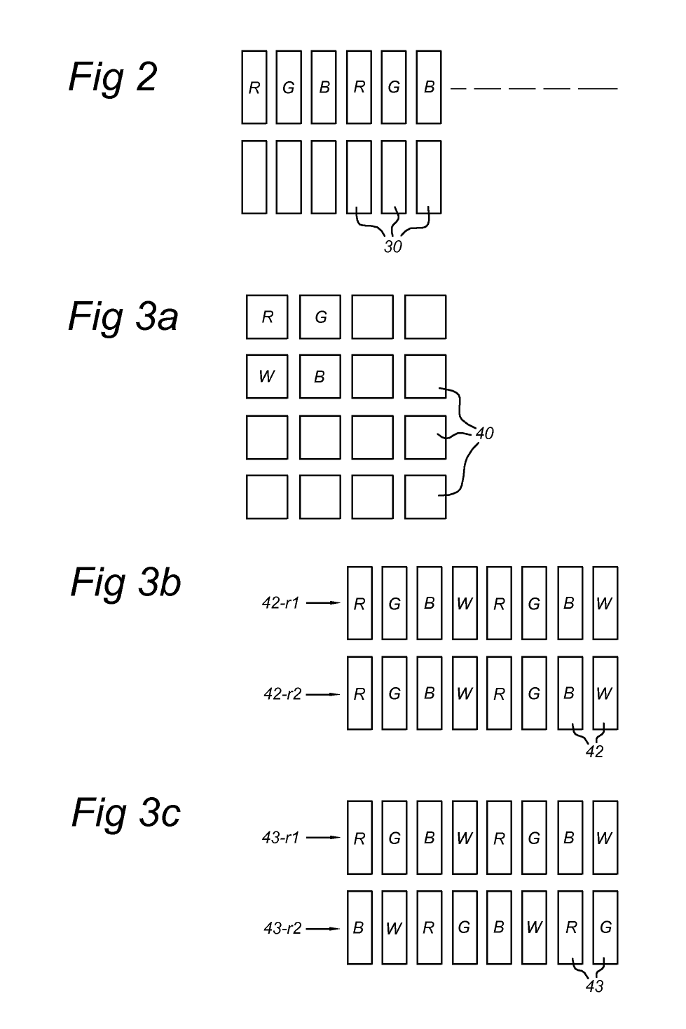

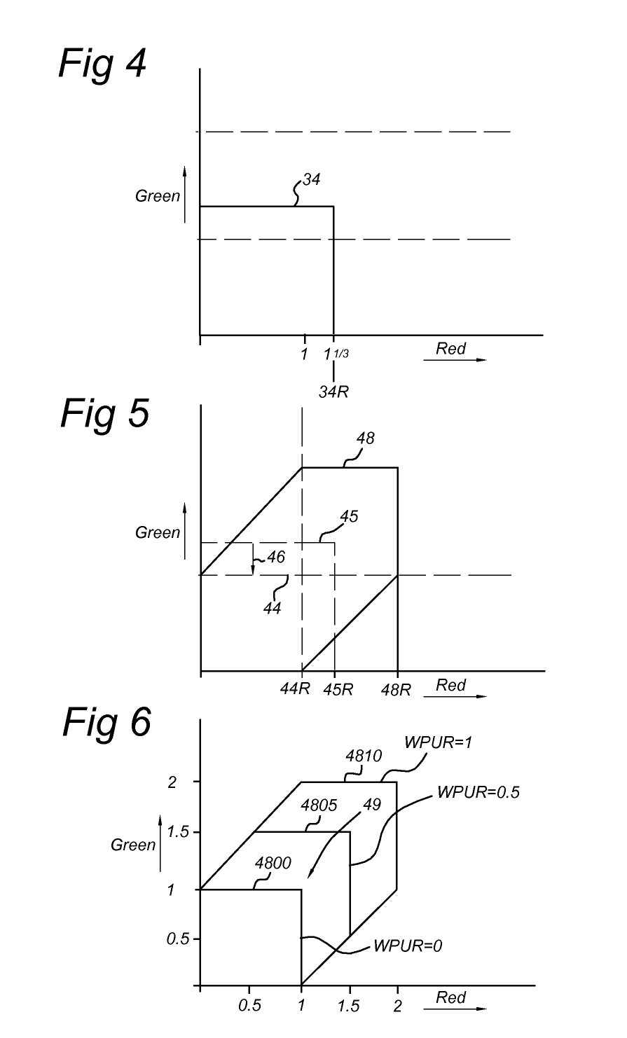

FIG. 2 schematically shows a pixel arrangement for an RGB display, FIG. 3a and FIG. 3b/c show pixel arrangements for an RGBW display, FIG. 4 schematically shows an aspect of a color space for an RGB display and FIG. 5 schematically shows an aspect of a color space for an RGBW display. FIG. 3-FIG. 5 will be used to illustrate the effect of actions a)-c) and action ii).

FIG. 2 shows an example of a typical pixel layout 30 of red pixels R, green pixels G and blue pixels B in an RGB display, e.g. of a transmissive type LCD equipped with a backlight. For the RGB display, one third of the display area may be composed of red pixels, one third of green pixels and one third of blue pixels. For the color filters, a filter transmission may e.g. be 33% for each of the three colors. The total maximum transmission of the RGB display is a product of the relative area and the filter transmission, and is thus ⅓*33%+⅓*33%+⅓*33%=33%. The simultaneous contrast for the RGB display is e.g. defined from comparing a red image part to a white image part, and has a ratio of (⅓*33%):33%=1:3 in the given example.

FIG. 3a, FIG. 3b and FIG. 3c show pixel arrangements 40, 42, 43 for an RGBW display. FIG. 3a shows an example of a so-called checkerboard layout 40 of red pixels R, green pixels G, blue pixels B and white pixels W in an RGBW display. FIG. 3b shows an example of an alternative, so-called stripe layout 42 of red pixels R, green pixels G, blue pixels B and white pixels W in an RGBW display. In FIG. 3b, the red pixels R, the green pixels G, the blue pixels B and the brightness enhancing pixels W of a first row 42-r1 and of a second row 42-r2 are arranged with pixels of equal color in the first row 42-r1 and in the second row 42-r2 located adjacently, resulting in columns of equally colored pixels. FIG. 3c shows another example of another alternative, so-called stripe layout 43 of red pixels R, green pixels G, blue pixels B and white pixels W in an RGBW display. In FIG. 3c, the red pixels R, the green pixels G, the blue pixels B and the brightness enhancing pixels W of a second row 43-r2 are located in a shifted position with respect to pixels of equal color in a first row 43-r1. The layout 43 of FIG. 3c may be advantageously be used in combination with sub-pixels rendering, which may allow a reduced number of pixels for a same perceived resolution. The reduced number of pixels may allow a further brightness increase as it may allow an increase of pixel aperture. It is noted that also alternative pixel layouts than those illustrated in FIG. 3b and FIG. 3c may be used with embodiments of the invention. Using the same color filters in the RGBW display as in the RGB display described above, one quarter of the display area may be composed of red pixels, one quarter of green pixels, one quarter of blue pixels and one quarter of white pixels. The white pixels may employ a neutral color filter or no color filter at all, and thus have a filter transmission of 100%. As a result, the total maximum transmission of the RGBW display is then ¼*33%+¼*33%+¼*33%+¼*100%=50%. The simultaneous contrast for the RGBW display is e.g. defined from comparing a red image part to a white image part, which has a ratio of (25%*33%):50%=1:6.

When comparing the RGB display with the RGBW display, several observations can be made. Firstly, in this example, the total maximum transmission of the RGBW display is thus increased to 150% of the total maximum transmission of the RGB display, and hence the brightness of the RGBW display is 150% of the corresponding RGB display (when using the same backlight brightness). Secondly, in this example, the simultaneous contrast for the RGBW display is a factor of 2 smaller than the simultaneous contrast for the RGB display. As a result, image parts with saturated colors may appear darker on the RGBW display compared to image parts with saturated colors on the RGB display. This effect may be referred to as the simultaneous contrast artifact. The simultaneous contrast artifact may be annoying as it may be experienced by a viewer as somewhat unnatural or unrealistic.

It is remarked that similar comparisons hold for other LCD types, other pixel sizes and pixel configurations, and other display types, e.g. OLED displays.

FIG. 4 schematically shows an aspect of a color space for an RGB display and FIG. 5 schematically shows an aspect of a color space for an RGBW display wherein the brightness of a single white pixel is substantially equal to the summed brightness of a single red, a single green and a single blue pixel as may be a typical configuration. FIG. 4 and FIG. 5 show a projection of the color space on the Red-Green plane, with a red color component along the horizontal axis and a green color component along the vertical axis. Line 34 in FIG. 4 show the border of achievable composed color in an RGB display with a top-right point associated with the projection of a white color wherein red, green and blue are all driven at maximum drive value. Line 45 and line 48 in FIG. 5 show the borders of achievable composed color in an RGB display and an RGBW display respectively, each with a top-right point associated with the projection of a white color wherein red, green, blue, and—for the RGBW display—white are all driven at maximum drive value. Line 45 in FIG. 5 corresponds to line 34 in FIG. 4. At a maximum drive value of the red pixel in an RGB display, the red color component has an amplitude indicated with 34R in FIG. 4. The red color component 44R associated with the red pixel in an RGBW display is indicated in FIG. 5, together with the red color component 45R associated with the red pixel in the RGB display (corresponding to 34R in FIG. 4). The red color component associated with the red pixel in an RGBW display is 25%/33%=75% of the red color component 45R associated with the red pixel in the RGB display in this example. This explains in part a reduction in brightness of a fully saturated red image part (when driven with the same backlight brightness). The red color component associated with a maximum white image part, with a fully driven red pixel together with a fully driven white pixel, in an RGBW display is indicated in FIG. 5 with 48R and is red color component 45R associated with the red pixel in the RGB display. Hence, in this example, a fully white image part has 50% more brightness in an RGBW display than in an RGB display. As a result, in an image with red image parts and white image parts, the red image part may be less bright on an RGBW display than on an RGB display while at the same time the white parts are brighter, which may cause the simultaneous contrast artifact to be perceived even more pronounced.

FIG. 6 schematically shows an aspect of a color space for an RGBW display according to the invention. Line 4800, 4805 and 4810 respectively show the borders of achievable composed color in an RGBW display, each with a top-right point associated with the projection of a white color wherein red, green and blue are all driven at maximum drive value, and white is driven with a brightness-enhancing-pixel utilization factor (WPUR) of 0.0, 0.5 and 1.0. Arrow 49 indicates the change of the borders of achievable composed color with decreasing brightness-enhancing-pixel utilization factor (WPUR). With the description given above, the skilled person will understand when inspecting FIG. 6, that reducing the brightness-enhancing-pixel utilization factor (WPUR) will decrease the achievable maximum brightness, while decreasing the simultaneous contrast artifact.

With the display module according to the invention, the brightness-enhancing-pixel utilization factor is made dependent on characteristics of the input image. By a) analyzing the color input values of the input image pixels of the input image for determining a degree of saturation of the input image and b) determining a brightness-enhancing-pixel utilization factor WPUR in dependence on at least the degree of saturation, the brightness-enhancing-pixel utilization factor may be determined for each individual image. The brightness-enhancing-pixel utilization factor is then used to c) color map the color input values to RGBW output values using at least the brightness-enhancing-pixel utilization factor WPUR. The color mapping may be performed using known methods using a fixed brightness-enhancing-pixel utilization factor (WPUR), as will be described below. In effect, displaying the image on the RGBW display may be achieved with an acceptable level of simultaneous contrast artifact.

In an embodiment, the display 10 is a LCD display. The LCD display 10 may be a passive matrix display or, alternatively, an active matrix display. The LCD display 10 may be a reflective display, a transmissive display, or alternatively a transflective display.

In an embodiment, the display module further comprises:
a light source 20, the light source 20 being arranged to illuminate the LCD display 10 with a light source brightness, and
a light source controller 22, the light source controller 22 being arranged to determine the light source brightness in dependence on at least one of:
   the color input values of the input image pixels of the input image,
   the RGBW output values,
   the degree of saturation,
   the degree of luminance, and
   the brightness-enhancing-pixel utilization factor WPUR, and to control the light source 20.

The light source 20 may be a backlight for illuminating the LCD display 10 from behind or, alternatively, a frontlight for illuminating the LCD display 10 from a side of the viewer.

The light source controller 22 may be arranged to determine the light source brightness in analogy to so-called dynamic backlight control techniques as known in the art.

In an alternative embodiment, the display is an OLED display. The OLED display 10 may be a passive matrix display or, alternatively, an active matrix display. The OLED display 10 may comprise a small molecule OLED material, or alternatively or additionally a polymer LED material, as active material for light emission.

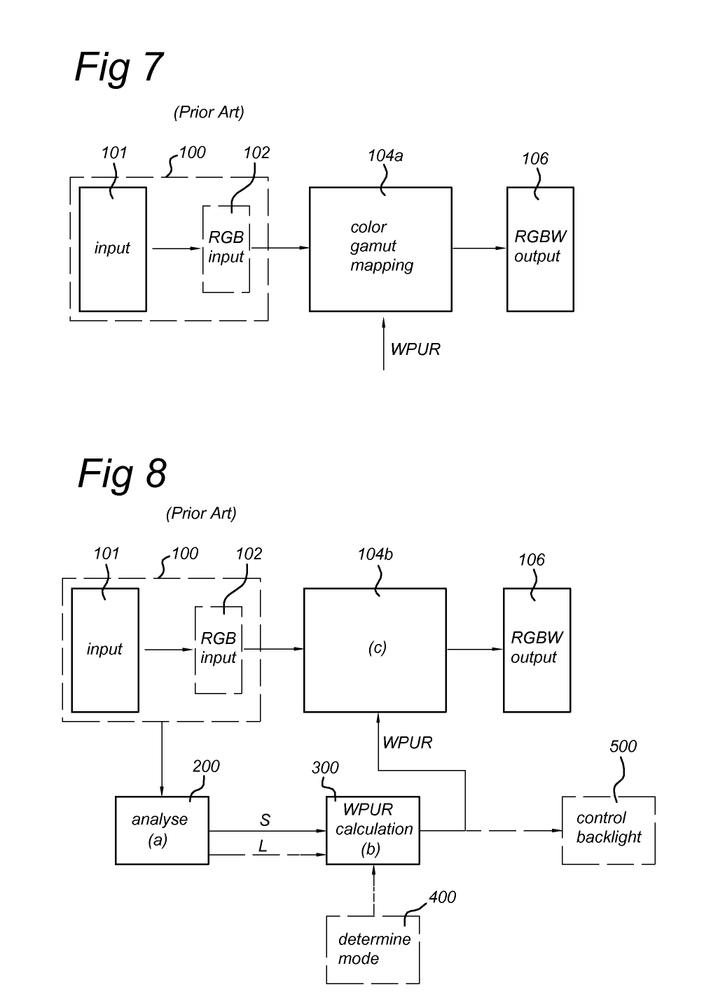

FIG. 7 schematically shows a prior art method arranged for color gamut mapping of color input values to RGBW output values for an RGBW display. The method is arranged to receive 100 color input values of input image pixels of an input image, color map 104a the color input values to RGBW output values using the brightness-enhancing-pixel utilization factor WPUR, and output 106 the RGBW output values. The action 100 of receiving color input values may be arranged for receiving RGB input values. The action 100 of receiving 100 color input values may be alternatively or additionally be arranged for comprising the action 101 of receiving the input image in a first color format, e.g. YUV, and the action 102 of converting to a second color format, e.g. RGB.

In color mapping 104a, the prior art method uses a value of the brightness-enhancing-pixel utilization factor WPUR which is fixed and independent of characteristics of the input image. Some prior art methods may use a value of 100% for achieving maximum brightness. Other prior art methods may use a value of e.g. 70% for achieving a compromise between brightness and simultaneous contrast. Other prior art methods may use a value associated with the ratio of pixel area of the W pixel relative to the R, G, B pixels. E.g., B. W.-Lee at al, “40.5L: Late-News Paper: TFT-LCD with RGBW Color System”, SID 03 DIGEST, p. 1212-1215 uses a constant scaling factor 1+w as a fixed value for the brightness-enhancing-pixel utilization factor (WPUR).

Color mapping is typically performed from RGB to RGBW, but may alternatively be performed from another color space to RGBW, such as from YUV to RGBW.

FIG. 8 schematically shows an embodiment of a method according to the invention. The method comprises:
a) analyzing 200 the color input values of the input image pixels of the input image for determining a degree of saturation S of the input image;
b) determining 300 a brightness-enhancing-pixel utilization factor WPUR for the input image in dependence on at least the degree of saturation S;
c) color mapping 104b of the color input values to the RGBW output values using at least the brightness-enhancing-pixel utilization factor WPUR.

The input image may be received in block 100 and the RGBW output values may be outputted in a similar manner as described above with reference to FIG. 7.

With the method according to the invention, the brightness-enhancing-pixel utilization factor is made dependent on characteristics of the input image. The RGBW output values thus achieved may be associated with an acceptable level of simultaneous contrast artifact when used for driving an RGBW display.

Color mapping 104b may be performed analogously to the color mapping 104a described above, but using the brightness-enhancing-pixel utilization factor WPUR determined in action b) instead of a fixed brightness-enhancing-pixel utilization factor WPUR as used in the prior art.

When used with a display with a light source 20, e.g. a backlight, the method may further comprise determining 500 a light source brightness of the light source, as will be described below in more detail. The method may further comprise controlling the light source with the light source brightness.

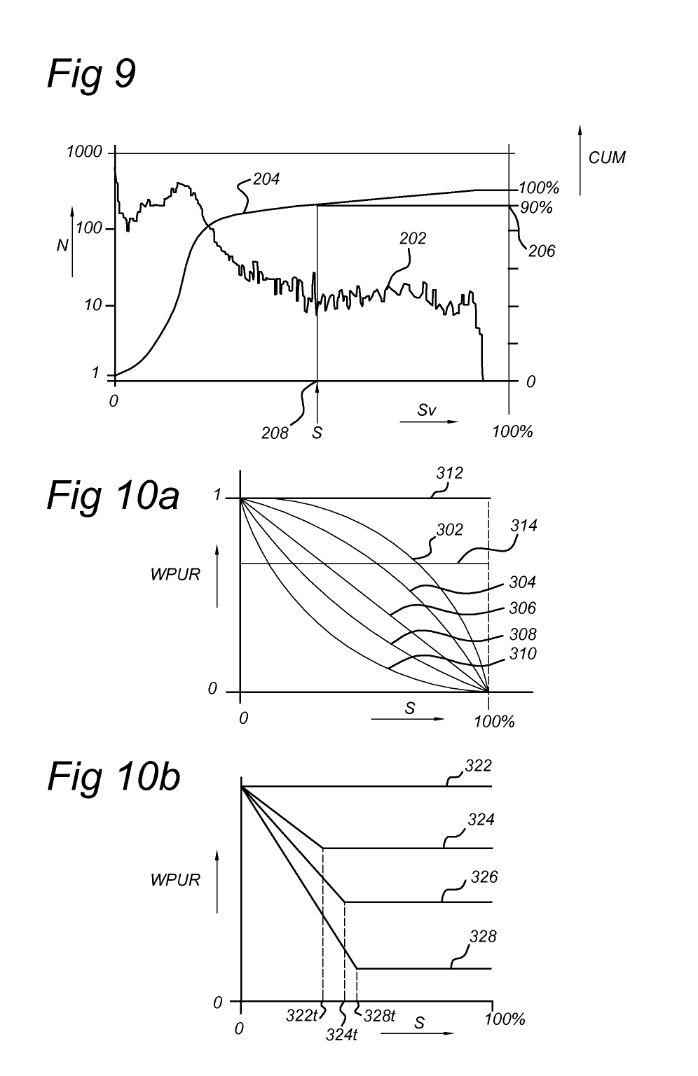

FIG. 9 schematically shows an aspect of an embodiment of a method according to the invention, associated with analyzing the color input values of the input image pixels of the input image for determining the degree of saturation of the input image.

In an embodiment, analyzing the color input values of the input image pixels of the input image for determining the degree of saturation of the input image comprises:
aa) determining a plurality of saturation values Sv from the color input values, each saturation value corresponding to a respective color input value; and
ab) determining the degree of saturation S of the input image from a statistical analysis of the plurality of saturation values Sv.

In a further embodiment, the action ab) comprises:
aba) forming a saturation distribution 202 from the plurality of saturation values; and
abb) determining the degree of saturation S of the input image from the saturation distribution 202.

In an alternative or additional further embodiment, the action ab) comprises:
aba′) applying respective weights to each of the plurality of saturation values Sv for obtaining a plurality of weighted saturation values; and
abb′) comparing the plurality of weighted saturation values using a pre-determined threshold 206 for obtaining the degree of saturation S of the input image.

In action aa), respective color input values may e.g. be associated with a red input pixel value Rin, a green input pixel value Gin and a blue input pixel value Bin. The saturation value Sv corresponding to a respective color input value may then e.g. be determined as a distance between the color input value and a vector corresponding to white in a 3-dimensional color space. I.e., when the color input value is a non-colored grey value with Rin=Gin=Bin, the corresponding saturation value may be 0. When the color input value corresponds to a saturated color such as Rin≠0, e.g. Rin=Rmax, Bin=Gin=0, the corresponding saturation value may be maximal, and e.g. normalized to 100%. The saturation value Sv may e.g. be determined as a normalized projection of a (Rin, Gin, Bin) input vector on a plane defined by Rin+Gin+Bin=1, wherein the input pixel values Rin, Gin and Bin are normalized values within a range of zero to one. Such normalized projection may e.g. be expressed as:

$$Sw = \sqrt{\frac{3}{2} - \frac{{( Rin + Gin + Bin )}^{2}}{2 * ( {Rin}^{2} + {Gin}^{2} + {Bin}^{2} )}} .$$

It will be understood that alternative measures may be used for determining the saturation value Sv, e.g. the color input values Rin, Gin, Bin may first be converted from an RGB color space to a so-called CIE 1976 (L*, a*, b*) color space, and the saturation value Sv may then be determined as

Sv=√(a*²+b*²).

The statistical analysis of the plurality of saturation values Sv in action ab) may e.g. be performed as shown in FIG. 9. FIG. 9 shows a saturation distribution 202 in the form of a histogram, wherein the horizontal axis corresponds to bins of saturation value Sv color input values and the left vertical axis corresponds to a number of occurrences N of the saturation value Sv of the corresponding bin in the input image. In the example shown, the number of occurrences is weighted with a pre-determined weight of unity. The number of occurrences may alternatively be weighted e.g. with weights determined from e.g. at least one of the saturation value and the luminance value. A statistical analysis may be made as shown in FIG. 9 by determining a normalized running sum 204 of the saturation distribution 202 from accumulating the bin content of the histogram from left to right and normalizing with the total content of the histogram. The right vertical axis corresponds to the value CUM of the normalized running sum. The normalized running sum 204 will thus show a monotonous increase from 0 to 100%. The degree of saturation S may then be obtained by comparing the normalized running sum 204 against a pre-determined threshold 206, of e.g. 90%, and determining the degree of saturation S as a value 208 of the saturation value Sv at which the pre-determined threshold 206 is reached. As a result, the degree of saturation S may be small when the input image largely comprises color input values with a small saturation value, i.e. a relatively pale input image, whereas the degree of saturation S may be large when the input image largely comprises color input values with a large saturation value, i.e. a relatively saturated input image or an image of a relatively saturated area of a significant size.

The statistical analysis may alternatively comprise one or more alternative statistical methods, e.g. associated with determining an average, a median or other known statistical measures.

In an embodiment, analyzing the color input values of the input image pixels of the input image for determining the degree of luminance L of the input image comprises:
aa2) determining a plurality of luminance values Lv from the color input values, each luminance value Lv corresponding to a respective color input value; and
ab2) determining the degree of luminance L of the input image from a statistical analysis of the plurality of luminance values Lv.

In action aa2), respective color input values may e.g. be associated with a red input pixel value Rin, a green input pixel value Gin and a blue input pixel value Bin. The luminance value Lv corresponding to a respective color input value may then e.g. be determined as a weighted sum of the red input pixel value, the green input pixel value and the blue input pixel value, e.g., as

Lv=30%*Rin+60%*Gin+10%*Bin, or as

Lv=(Rin+Gin+Bin)/3.

The luminance value Lv may alternatively be determined as a maximum value of the red input pixel value, the green input pixel value and the blue input pixel value, i.e. as

Lv=max(Rin,Gin,Bin).

The red input pixel value, the green input pixel value and the blue input pixel value may be used directly, or after a gamma correction has been applied.

Action aa2) may determine the luminance value Lv corresponding to a respective color input value as the luminance component Y of the color input value when color input values are in a YUV color format.

In action ab2), the degree of luminance L may be determined using similar techniques as the degree of saturation, as described above. Reference is thus made to the description above. As a result, the degree of luminance L may be small when the input image largely comprises color input values with a small luminance value, i.e. a relatively dark input image, whereas the degree of luminance L may be large when the input image largely comprises color input values with a large luminance value, i.e. a relatively bright input image or an image with a relatively bright area of a significant size.

In an embodiment, the method further comprises:
a2) analyzing the color input values of the input image pixels of the input image for determining a degree of luminance L of the input image; and
b2) determining the brightness-enhancing-pixel utilization factor WPUR is performed in further dependence on the degree of luminance L.

In an embodiment, the brightness-enhancing-pixel utilization factor WPUR is determined from a function of at least the degree of saturation, the function being substantially a monotonously decreasing function of the degree of saturation.

Thus, when the degree is saturation S increases, the brightness-enhancing-pixel utilization factor WPUR may decrease and the resulting simultaneous contrast may thus limited.

The function may be a smooth function. The function may be definite monotonously decreasing, or alternatively comprise constant parts. The function may decreased to zero (resulting in a color space as shown with line 4800 in FIG. 6), or alternatively to a non-zero value, at a 100% degree of saturation. The function may be implemented using a real-time calculation, or alternatively or additionally use a look-up table.

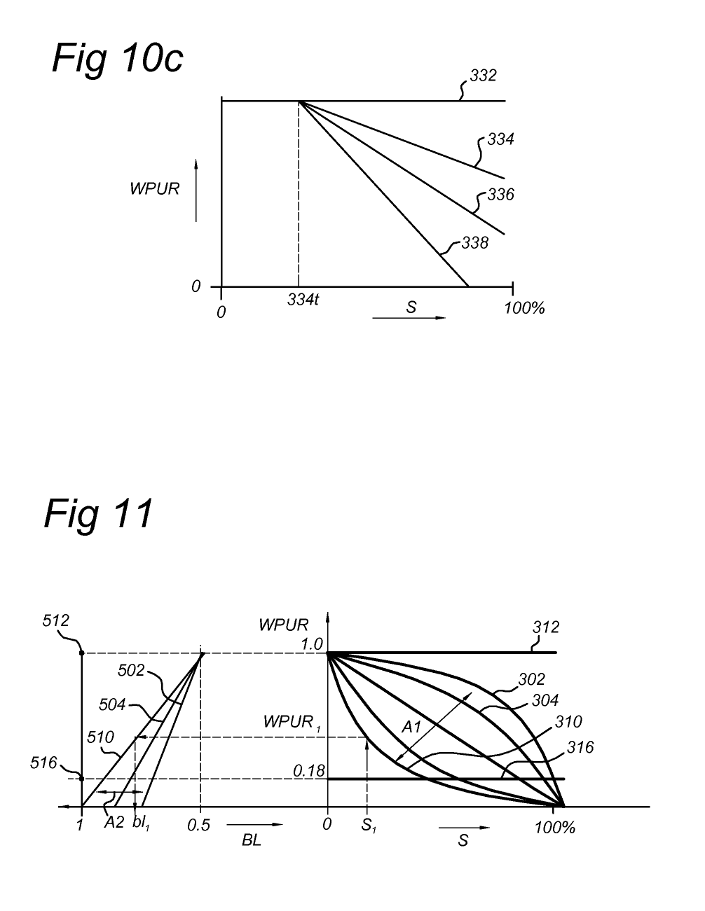

Examples of suitable functions are shown in FIG. 10a, FIG. 10b and FIG. 10c. FIG. 10a shows suitable functions 302, 304, 306, 308, 310, which are all monotonously decreasing towards zero and are associated with various levels of compromise between brightness and simultaneous contrast artifact. FIG. 10a also shows two prior art functions 312, 314 with fixed values for the brightness-enhancing-pixel utilization factor, here 1.0 for function 312 and 0.7 for function 314. FIG. 10b shows alternative functions 324, 326, 328, which are decreasing up to respective thresholds 332t, 324t and 328t and have constant parts at larger degree of saturation. FIG. 10c shows alternative functions 334, 336, 323, which are constant up to a common thresholds 334t (in alternative embodiments, the thresholds may also be different) and are decreasing at larger degree of saturation.

In an embodiment, the brightness-enhancing-pixel utilization factor WPUR is determined from a two-parameter function of the degree of saturation and the degree of luminance.

This allows to tune the balance between achievable brightness (large WPUR) and instantaneous contrast (low WPUR) also in dependence on the degree of luminance.

The two-parameter function may e.g. correspond to function 302 of FIG. 10 for a large degree of luminance, to function 310 of FIG. 10 for a small degree of luminance, and gradually changing from function 302 via function 304, 306 and 308 with decreasing degree of luminance.

In a further embodiment, the function of at least the degree of saturation is selected from a plurality of pre-determined functions 302-312; 322-328; 332-338 of the degree of saturation, and the method further comprises:
determining 400 a mode of operation of the display, and
selecting the function from the plurality of pre-determined functions 302-312; 322-328; 332-338 in dependence on the mode of operation.

The mode of operation may e.g. be determined by a selection of a human user or a control system between different levels of compromise. The mode of operation may e.g. be determined in dependence on a type of input image, e.g. indicating whether the input image is a photo, a menu, or other graphics. The mode of operation may e.g. be determined in dependence on the environment in which the display is operated, e.g. with a preference for large brightness at the cost of simultaneous contrast when used outdoors in bright sunlight: a selection could than be made between e.g. functions 302-310 and one or more functions 312, 314 associated with a constant brightness-enhancing-pixel utilization factor as shown in FIG. 10a, between functions 324-328 and a constant function 322 as shown in FIG. 10b, or between functions 334-338 and a constant function 332 as shown in FIG. 10c.

In a further embodiment, the function of at least the degree of saturation decreases substantially to zero at a pre-determined threshold of the degree of saturation.

E.g., function 338 of FIG. 10c may be advantageously applied when images with a high degree of saturation are to be displayed without increasing the brightness of bright, e.g., white, image parts.

As shown in FIG. 8, a further embodiment of the method may comprise determining 500 a light source brightness, when the display module 2 comprises a light source 20 for illumination the display 10. Determining the light source brightness may be performed in dependence on at least one of:
the color input values of the input image pixels of the input image,
the RGBW output values,
the degree of saturation S,
the degree of luminance L, and
the brightness-enhancing-pixel utilization WPUR.

The method may further comprise controlling the light source 20 with the light source brightness. Determining the light source brightness may be performed in further dependence on a mode of operation of the display. An exemplary embodiment of the latter method will be described with reference to FIG. 11.

The right graph of FIG. 11 shows again the suitable functions 302, 304, 306, 308, 310 of FIG. 10a. FIG. 11 also shows again the prior art function 312 with a fixed value for the brightness-enhancing-pixel utilization factor of 1.0. FIG. 11 further shows a further constant function 316 with a low, fixed value for the brightness-enhancing-pixel utilization factor of 0.18. Depending on the mode of operation, one of the functions 302-310, 312, 316 is selected as the function of at least the degree of saturation for determining the brightness-enhancing-pixel utilization factor WPUR.

The left graph of FIG. 11 shows exemplary relationships between the brightness-enhancing-pixel utilization factor WPUR on the vertical axis and a light source dimming factor BL on the horizontal axis. Since the brightness-enhancing-pixel utilization factor WPUR may affect the maximum brightness of white patches, a dynamically changing brightness-enhancing-pixel utilization factor WPUR depending on image content may also dynamically change the brightness of white patches. This may be observed as a flicker artifact. By compensating a high brightness-enhancing-pixel utilization factor WPUR with a lower backlight luminance the flicker artifact may be solved and at the same time power may be reduced. The light source dimming factor BL may be used as an additional factor applied to the light source brightness as determined with prior art techniques for backlight dimming. These prior art techniques for backlight dimming may e.g. determine a light source brightness in dependence on at least one of the color input values of the input image pixels of the input image, the RGBW output values and the degree of luminance L. Relationship 502 is associated with the mode of operation associated with function 302, relationship 504 is associated with the mode of operation associated with function 304, relationship 510 is associated with the mode of operation associated with function 310. Arrow A1 indicated that in an embodiment, the modes may gradually change from function 302 to 310, with these modes being parameterized with a factor A2 and resulting in functions that may be expressed e.g. as:

WPUR=(1−S)^{A1},

with arrow A2 indicating a corresponding gradual change from relationship 502 to 510 in which a further factor A2 may be used for setting a backlight control range, e.g. according to a relationship:

BL=A2−(A2−0.5)*WPUR=A2−(A2−0.5)*(1−S)^{A1}.

The mode associated with function 312 is a mode where maximum luminance is required independent of saturation value or image content and where simultaneous contrast artifacts are taken for granted. For this mode, with fixed brightness-enhancing-pixel utilization factor WPUR, there will be no backlight dimming and the light source dimming factor BL will be 1, as indicated by point 512. The mode associated with function 316 is a mode where minimum simultaneous contrast artifact is required independent of saturation value or image content and where a lower luminance level is taken for granted. For this mode associated with function 316, with fixed brightness-enhancing-pixel utilization factor WPUR, there will be no backlight dimming and the light source dimming factor BL will be 1, as indicated by point 516.

As an example, when the degree of saturation S is S₁, the brightness-enhancing-pixel utilization WPUR as determined from function 316 associated with the mode of operation is WPUR₁, the light source dimming factor BL is determined from relationship 510 to be bl₁. In this example, the light source dimming factor BL is thus determined in dependence on the degree of saturation S, the brightness-enhancing-pixel utilization WPUR and the mode of operation of the display. This allows to determine the light source dimming factor BL, and by that the light source brightness, as a well-controlled comprise between backlight power, display brightness and perceived image quality.

It should be noted that the above-mentioned embodiments illustrate rather than limit the invention, and that those skilled in the art will be able to design many alternative embodiments without departing from the scope of the appended claims. E.g., alternative functions may be used than those explicitly described with reference to FIG. 10a, FIG. 10b and FIG. 10c, without departing from the scope of the invention and the appended claims. In the claims, any reference signs placed between parentheses shall not be construed as limiting the claim.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

We claim:

1. A method arranged for color gamut mapping of color input values of input image pixels of an input image to RGBW output values for an RGBW display, the RGBW display comprising red pixels (R), green pixels (G), blue pixels (B) and brightness enhancing pixels (W), the method comprising:
a) analyzing the color input values of the input image pixels of the input image for determining a degree of saturation (S) of the input image;
b) determining a brightness-enhancing-pixel utilization factor (WPUR) for the input image in dependence on at least the degree of saturation (S);
c) color mapping of the color input values to the RGBW output values using at least the brightness-enhancing-pixel utilization factor (WPUR).

2. The method according to claim 1, further comprising:
a2) analyzing the color input values of the input image pixels of the input image for determining a degree of luminance (L) of the input image; and wherein
b2) determining the brightness-enhancing-pixel utilization factor (WPUR) is performed in further dependence on the degree of luminance (L).

3. The method according to claim 1, wherein the brightness-enhancing-pixel utilization factor (WPUR) is determined from a function of at least the degree of saturation, the function being substantially a monotonously decreasing function of the degree of saturation.

4. The method according to claim 3, wherein the function is selected from a plurality of pre-determined functions of the degree of saturation (S), and the method further comprises:
determining a mode of operation of the display, and
selecting the function from the plurality of pre-determined functions in dependence on the mode of operation.

5. The method according to claim 3, wherein the function decreases substantially to zero at a pre-determined threshold of the degree of saturation.

6. The method according to claim 1, wherein analyzing the color input values of the input image pixels of the input image for determining the degree of saturation of the input image comprises:
aa) determining a plurality of saturation values (Sv) from the color input values, each saturation value corresponding to a respective color input value; and
ab) determining the degree of saturation (S) of the input image from a statistical analysis of the plurality of saturation values (Sv).

7. The method according to claim 2, wherein analyzing the color input values of the input image pixels of the input image for determining the degree of luminance of the input image comprises:
aa2) determining a plurality of luminance values (Lv) from the color input values, each luminance value corresponding to a respective color input value; and
ab2) determining the degree of luminance (L) of the input image from a statistical analysis of the plurality of luminance values (Lv).

8. A display module, comprising:
a display comprising red pixels (R), green pixels (G), blue pixels (B) and brightness enhancing pixels (W) arranged to be driven with pixel drive values; and
a display controller, arranged to:
i) receive color input values of input image pixels of an input image;
a) analyze the color input values of the input image pixels of the input image for determining a degree of saturation (S) of the input image;
b) determine a brightness-enhancing-pixel utilization factor (WPUR) in dependence on at least the degree of saturation (S);
c) color map the color input values to RGBW output values using at least the brightness-enhancing-pixel utilization factor (WPUR), and
ii) drive the display with pixel drive values corresponding to the RGBW output values.

9. A display module according to claim 8, wherein the brightness enhancing pixels are selected from a group comprising white pixels and yellow pixels.

10. A display module according to any one of claims 8, wherein the red pixels (R), the green pixels (G), the blue pixels (B) and the brightness enhancing pixels (W) have substantially equal sizes.

11. A display module according to any one of claims 8, wherein the display is a LCD display.

12. A display module according to claim 11, wherein the display module further comprises:
a light source, the light source being arranged to illuminate the LCD display with a light source brightness, and
a light source controller, the light source controller being arranged to determine the light source brightness in dependence on at least one of:
the color input values of the input image pixels of the input image,
the RGBW output values,
the degree of saturation (S),
the degree of luminance (L), and
the brightness-enhancing-pixel utilization factor (WPUR),
and to control the light source.

13. A display module according to claim 8, wherein the display is an OLED display.

14. An apparatus, comprising:
a display module according to any one of the claim 8, and
an apparatus controller arranged to provide the input image to the display module.
